(19) United States
(12) Patent Application Publication
(10) Pub. No.: US 2003/0123080 A1
(43) Pub. Date: Jul. 3, 2003

(54) Image forming device and method for controling the same

(75) Inventor: Aiko Okajima, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/026,721

(22) Filed: Dec. 27, 2001

(51) Int. Cl. B41J 1/00; G06F 15/00

(52) U.S. Cl. 358/1.15; 358/1.9

(57) ABSTRACT

A receiving module receives print jobs from outside. A storing module stores the print jobs received by the receiving module. A printing module implements the print job stored by the storing module. A controlling module discriminates whether or not the print jobs received by the receiving module include special print jobs and controls implementation of printing done by the printing module.

### BACKGROUND OF THE INVENTION

1. Field of the Invention

The present invention relates to an image forming device and a method of controlling the same, and particularly to an image forming device which is designed so as to, concerning the image forming device such as a network printer used at an office, effectively deal with special print jobs such as printing-out by using, for example, tabbed paper, which is different from regular paper, as printing paper, and the method of controlling the same.

2. Description of the Related Art

In general, a printer commonly used by plural users at an office and the like is connected as a so-called network printer via a printer server to plural personal computer (PC) terminals by LAN and the like.

The printer server receives the print jobs sent from the respective PC terminals and stores them in a memory.

The printer, at the same time, implements the print jobs following an order in which the printer server receives the print jobs, and prints images and characters on paper.

Now, it has been known that, in the case where the print jobs include print jobs for special paper besides regular paper such as thick paper or tabbed paper, the printer easily jams while printing the special paper.

When the printer jams, the print jobs are suspended without being reported to the users.

Moreover, when the print jobs for the paper including such special paper are processed, even when the printer does not jam, the print jobs are suspended without being reported to the users unless the special paper is loaded in a feeding cassette or a manual-feeding tray of the printer.

When the print jobs is suspended in this manner, the following print jobs that continue to be stored in the printer server cannot be implemented until one of the users notices the suspension and deals with the printer jam or loads the special paper.

### BRIEF SUMMARY OF THE INVENTION

In the light of the above-mentioned points, an object of the present invention is to provide an image forming device designed so as to effectively deal with special print jobs such as printing-out by using, for example, tabbed paper, and a method of controlling the same.

In order to attain the above-mentioned object, according to a first aspect of the present invention, there is provided an image forming device comprising:

a receiving module which receives print jobs from outside;

a storing module which stores the print jobs received by the receiving module;

a printing module which implements the print jobs stored by the storing module; and

a controlling module which discriminates whether or not the print jobs received by the receiving module include special print jobs and for controlling implementation of printing done by the printing module.

Moreover, according to a second aspect of the present invention, there is provided the image forming device according to the first aspect, wherein the special print jobs are print jobs for printing paper including at least one of thick paper, thin paper, colored paper, and tabbed paper which are different from regular paper.

Moreover, according to a third aspect of the present invention, there is provided the image forming device according to the first aspect, wherein the controlling module, in the case where the print jobs include the special print jobs, extracts the special print jobs from the storing module and controls the printing module to implement the special print jobs.

Moreover, according to a fourth aspect of the present invention, there is provided the image forming device according to the first aspect, wherein the controlling module, in the case where it is discriminated that the print jobs include the special print jobs, extracts the print jobs besides the special print jobs from the storing module and controls the printing module to implement the print jobs besides the special print jobs.

Moreover, according to a fifth aspect of the present invention, there is provided the image forming device according to the first aspect, wherein the controlling module includes a first discriminating module which discriminates whether or not the print jobs include the special print jobs, and a second discriminating module which, in the case where the first discriminating module discriminates that the print jobs include the special print jobs, extracts at least a part of the special print jobs from the storing module and discriminates whether or not the printing module should be controlled to implement at least a part of the special print jobs.

Moreover, according to a sixth aspect of the present invention, there is provided the image forming device according to the fifth aspect, wherein the controlling module further includes a third discriminating module which, in the case where the second discriminating module discriminates that the printing module should be controlled to implement at least a part of the special print jobs, discriminates whether or not at least a part of the special print jobs should be deleted from the storing module after the printing module implements at least a part of the special print jobs.

In order to attain the above-mentioned object, according to a seventh aspect of the present invention, there is provided an image forming device comprising:

receiving means for receiving print jobs from outside;

storing means for storing the print jobs received by the receiving means;

printing means for implementing the print jobs stored by the storing means; and

controlling means for discriminating whether or not the print jobs received by the receiving means include special print jobs, and for controlling implementation of printing done by the printing means.

Moreover, according to an eighth aspect of the present invention, there is provided the image forming device according to the seventh aspect, wherein the special print jobs are print jobs for printing paper including at least one of thick paper, thin paper, colored paper, and tabbed paper which are different from regular paper.

Moreover, according to a ninth aspect of the present invention, there is provided the image forming device according to the seventh aspect, wherein the controlling means, in the case where the print jobs include the special print jobs, extracts the special print jobs from the storing means and controls the printing means to implement the special print jobs.

Moreover, according to a tenth aspect of the present invention, there is provided the image forming device according to the seventh aspect, wherein the controlling means, in the case where it is discriminated that the print jobs include the special print jobs, extracts the print jobs besides the special print jobs from the storing means and controls the printing means to implement the print jobs besides the special print jobs.

Moreover, according to an eleventh aspect of the present invention, there is provided the image forming device according to the seventh aspect, wherein the controlling means includes a first discriminating means for discriminating whether or not the print jobs include the special print jobs, and a second discriminating means for, in the case where the first discriminating means discriminates that the print jobs include the special print jobs, extracting at least a part of the special print jobs from the storing means and for discriminating whether or not the printing means should be controlled to implement at least a part of the special print jobs.

Moreover, according to a twelfth aspect of the present invention, there is provided the image forming device according to the eleventh aspect, wherein the controlling means further includes a third discriminating means for, in the case where the second discriminating means discriminates that the printing means should be controlled to implement at least a part of the special print jobs, discriminating whether or not at least a part of the special print jobs should be deleted from the storing means after the printing means implements at least a part of the special print jobs.

In order to attain the above-mentioned object, according to a thirteenth aspect of the present invention, there is provided a method of controlling an image forming device for implementing print jobs from outside comprising:

receiving the print jobs from outside;

storing the print jobs to a storing portion;

implementing the print jobs stored to the storing portion; and

discriminating whether or not the print jobs include special print jobs and controlling implementation of the print jobs.

Moreover, according to a fourteenth aspect of the present invention, there is provided the method according to the thirteenth aspect, wherein the special print jobs are print jobs for printing paper including at least one of thick paper, thin paper, colored paper, and tabbed paper which are different from regular paper.

Moreover, according to a fifteenth aspect of the present invention, there is provided the method according to the thirteenth aspect, wherein the controlling, in the case where the print jobs include the special print jobs, extracts the special print jobs from the storing portion and causes the print jobs to be implemented.

Moreover, according to a sixteenth aspect of the present invention, there is provided the method according to the thirteenth aspect, wherein the controlling, in the case where it is discriminated that the print jobs include the special print jobs, extracts the print jobs besides the special print jobs from the storing portion and causes the print jobs besides the special print jobs to be implemented.

Moreover, according to a seventeenth aspect of the present invention, there is provided the method according to the thirteenth aspect, wherein the controlling includes first discriminating for discriminating whether or not the print jobs include the special print jobs, and second discriminating for, in the case where the first discriminating discriminates that the print jobs include the special print jobs, extracting at least a part of the special print jobs from the storing portion and for discriminating whether or not at least a part of the special print jobs should be implemented.

Moreover, according to an eighteenth aspect of the present invention, there is provided the method of controlling the image forming device according to the sixteenth aspect, wherein the controlling further includes third discriminating for, in the case where the second discriminating discriminates that at least a part of the special print jobs should be implemented, discriminating whether or not at least a part of the special print jobs should be deleted from the storing portion after at least a part of the special print jobs is implemented.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a schematic drawing showing a printing system to which an image processing device according to the present invention, a printer driver, and plural PC terminals are connected as a network;

FIG. 2 is a block diagram showing a structure of a main portion of the image processing device according to a first embodiment of the present invention that is built-in to the printing system in FIG. 1;

FIG. 3 is a flowchart of pre-processes for explaining actions of the image processing device according to the first to third embodiments of the present invention;

FIG. 4 is a flowchart for explaining a sub-routine of a reception process at the step S2 in FIG. 3;

FIG. 5 is a flowchart of a main process for explaining the actions of the image processing device according to the first and second embodiments of the present invention;

FIG. 6 is a flowchart for explaining the sub-routine for implementing special print jobs for paper that only includes tabbed paper at the step S38 in FIG. 5; and

FIG. 7 is a flowchart of the main process for explaining the actions of the image processing device according to the third embodiment of the present invention.

### DETAILED DESCRIPTION OF THE INVENTION

Reference will now be made in detail to the presently preferred embodiments of the invention as illustrated in the accompanying drawings, in which like reference numerals designate like or corresponding parts.

First of all, an explanation will be given of a summary of the present invention.

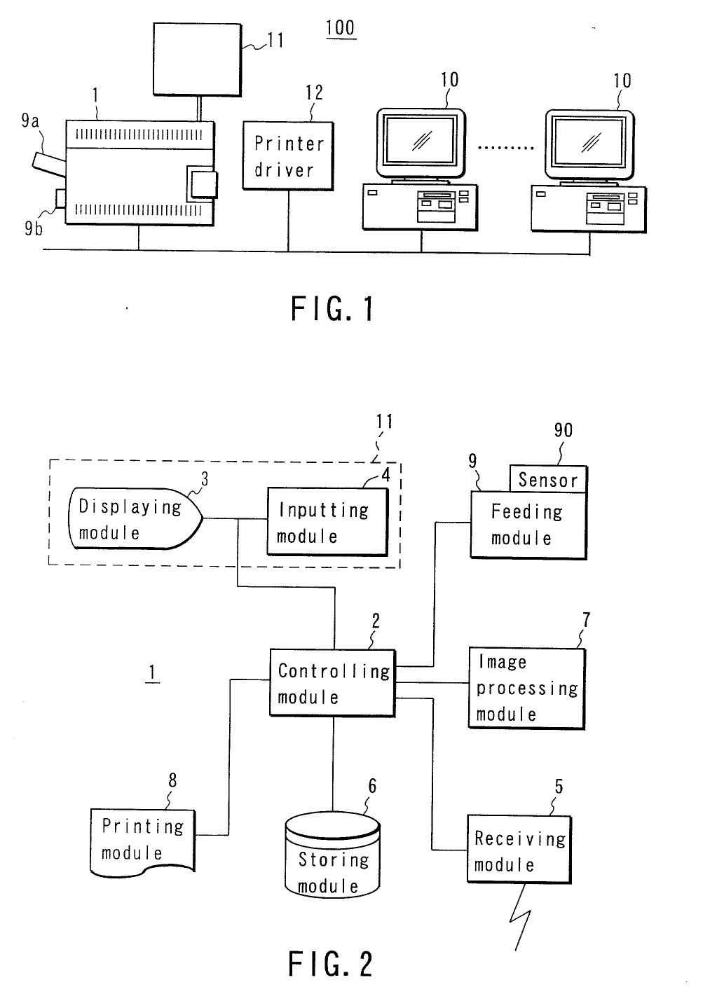

FIG. 1 is a schematic drawing showing a printing system 100 as a so-called network printer system to which an image processing device 1 according to the present invention, a printer driver 12, and plural PC terminals 10 are connected by a network such as a LAN.

That is, in the printing system 100 of the present invention as shown in FIG. 1, the respective users who desire implementation of the print job input data such as images or characters, which are necessary for printing, by operating the respective users' own PC terminals 10 or the printer driver 12, and transmit a command for the implementation of the printing based on the input data as the print job from the respective PC terminals 10 to the image processing device 1 via the network such as a LAN.

As will be described below, the image processing device 1 receives the print jobs transmitted from the respective PC terminals 10 or the printer driver 12 and stores them while basically implementing the print jobs in an order of reception.

At this time, as will be described below, the image processing device 1 according to the present invention is characterized by being able to effectively deal with the print jobs including special print jobs, which is the print job for special printing paper (special paper) including at least one of thick paper, thin paper, colored paper, and tabbed paper that are all different from regular paper, by preventing jams and the like from occurring.

That is, in the present invention, among the print jobs including, for example, regular print jobs for regular paper and the special print jobs for the special paper including the tabbed paper, the users can previously make a selection from a first printing mode for extracting the regular print jobs only for the regular paper besides the tabbed paper and for implementing them, a second printing mode for extracting the special print jobs only for the tabbed paper and for implementing them, and moreover, a third printing mode for extracting all the print jobs including the regular print jobs for the regular paper and the special print jobs for the special paper including the tabbed paper.

Owing to this, printing in desired modes previously selected by the users can be implemented.

Moreover, it is assumed that the users can designate whether or not deletion of printing data after the printing is allowed previously or after the printing.

Owing to this, when the users designate that the deletion of the printing data after the printing is not allowed previously or after the printing, the implementation of all of the print jobs including the printing on the tab paper becomes possible again after only the tabbed paper is tentatively printed.

In this manner, by implementing the print jobs including the special print jobs with the users' intervention, jams and the like are prevented from occurring so that the print jobs including the special print jobs can be effectively dealt with.

Besides, the image processing device 1 shown in FIG. 1 comprises an operation panel 11 operated by the users and two feeding cassettes 9a and 9b in which the special paper including the above-described tabbed paper can be set by the users.

Here, the tabbed paper indicates the printing paper that comprises a tab integrally projecting from one side of the rectangular-shaped paper.

Then, the special paper includes the thick paper, thin paper, colored paper, paper from foreign countries (for example, from the United States or China), and the like besides the tabbed paper.

Next, an explanation will be given of the embodiments of the present invention based on the summary as above.

(First Embodiment)

Hereinafter, an explanation will be given of a first embodiment of the present invention with reference to accompanying figures.

The first embodiment is applied to the case where print jobs transmitted from respective PC terminals 10 are received and stored to the image processing device 1.

FIG. 2 is a block diagram showing a structure of a main portion of the image processing device 1 according to the first embodiment of the present invention that is built-into the printing system in FIG. 1.

That is, as shown in FIG. 2, the image processing device 1 according to the first embodiment of the present invention has a controlling module 2 for controlling actions of the entire image processing device 1.

To the controlling module 2, there are connected an operation panel 11 with a touch-panel style that has functions as a displaying module 3 and an inputting module 4, a receiving module 5 for receiving the print jobs transmitted from the respective PC terminals 10 shown in FIG. 1, a storing module 6 for storing the print jobs received by the receiving module 5, an image processing module 7 for processing page data included in the print jobs as need arises, a printing module 8 for implementing the print jobs, and a feeding module 9 for feeding printing paper to the printing module 8.

Here, the feeding module 9 has two feeding cassettes 9a and 9b (refer to FIG. 1) and a manual-feeding tray that is not shown in figures, and has a sensor 90 for detecting the existence of the paper in each feeding cassette and the manual-feeding tray.

In these feeding cassettes 9a and 9b and the manual-feeding tray, there can be set special paper such as tabbed paper besides regular paper.

First of all, the receiving module 5 receives the print jobs from outside (in this case, from the respective PC terminals 10 connected to the image processing device 1 by a network).

Then, the controlling module 2 also functions as a discriminating module of the present invention so as to discriminate whether or not the print jobs received via the receiving module 5 include the print jobs for the special paper such as tabbed paper (such print jobs will be described as special print job below).

Besides, the print job for the special printing paper that can cause jams more easily compared with the printing on the regular paper is described as special print job here.

Moreover, the storing module 6 stores all print jobs received via the receiving module 5 and transmitted from the respective PC terminals 10.

In this case, the storing module 6 stores, particularly in the case where the controlling module 2 discriminates that the print jobs received via the receiving module 5 include the special print jobs, the special print jobs differently from the regular print jobs excluding special printing.

Moreover, the displaying module 3 displays a table (a list) of the print jobs including the special print jobs in the case where the controlling module 2 discriminates that the print jobs stored to the storing module 6 include the special print jobs.

Here, as a method of displaying the list of the print jobs including the special print jobs on the displaying module 3, there can be considered a method for displaying names of the users of the respective PC terminals 10 and the like besides a form that displays the names of the print jobs.

Moreover, the inputting module 4 accepts various sorts of operation inputs input by the user.

The user selects the print jobs including the special print jobs that the user desires to implement from the list of the print jobs including the special print jobs displayed on the displaying module 3, and inputs them via the inputting module 4.

Here, the displaying module 3 and the inputting module 4 are operation panels 11 with the touch-panel style so that the special print job that the user desires is selected when the user touches a corresponding item on a screen displayed via the displaying module 3.

Moreover, the image processing module 7 implements a process of, for example, shifting the page data to be printed by a size of a tab at the time of the printing on the tabbed paper.

Concerning this, there may be taken a design in which the feeding module 9 shifts a timing of feeding the tabbed paper by the size of the tab.

Moreover, the printing module 8 implements the printing of the images or characters in the page data included in the print jobs read out from the storing module 6 on the printing paper (including the tabbed paper) fed from the feeding module 9.

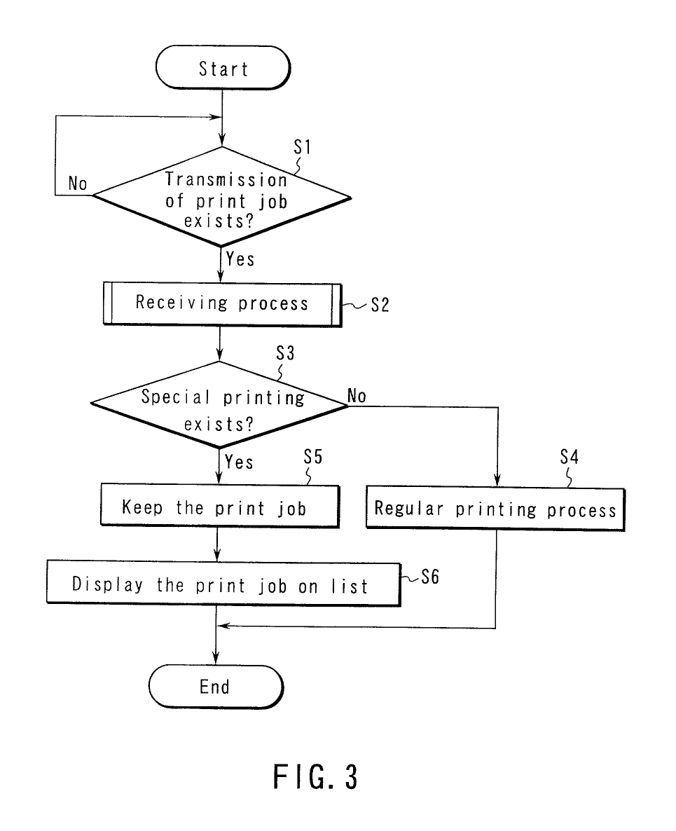

Next, an explanation will be given of the actions of the image processing device 1 according to the first embodiment of the present invention composed as above with reference to flowcharts shown in FIG. 3 to FIG. 6.

Here, FIG. 3 is a flowchart for explaining a procedure of pre-processes up to a process of displaying the table (the list) of the print jobs including the special print jobs (step S6) in the case where reception determination of the print jobs (step S1) implemented by the above-described controlling module 2 discriminates that the received print jobs include the special print jobs.

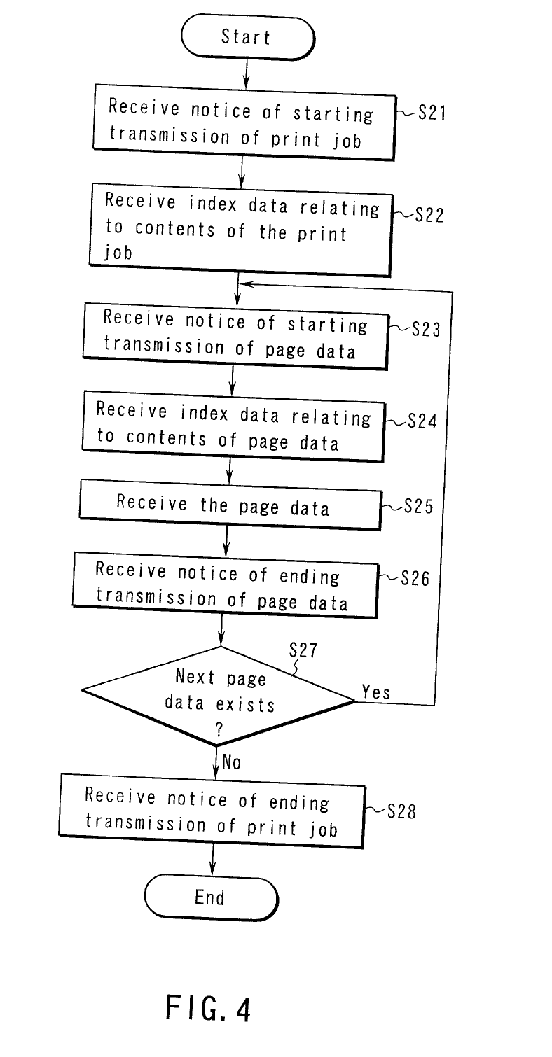

Moreover, FIG. 4 is a flowchart for explaining the procedure of a sub-routine of the reception process at step S2 in FIG. 3.

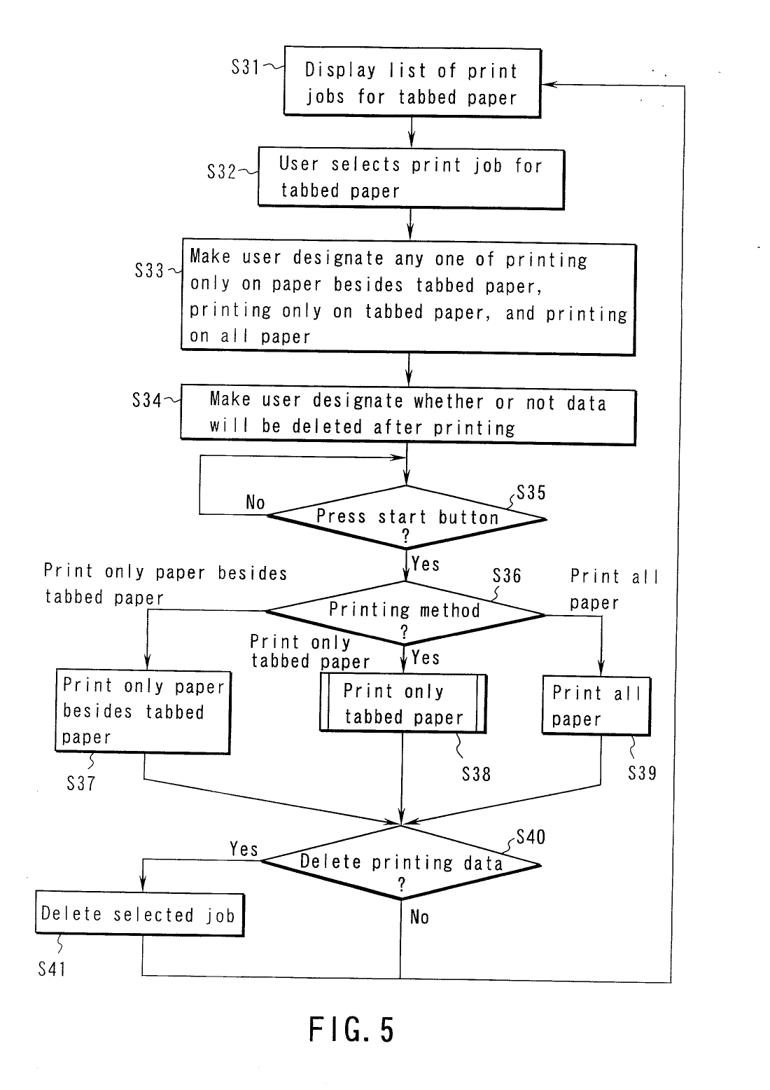

Then, FIG. 5 is a flowchart for explaining the procedure of the main process, which is the characterized part of the present invention, implemented after the process of displaying the table (the list) of the print jobs including the special print jobs at step S6 in FIG. 3.

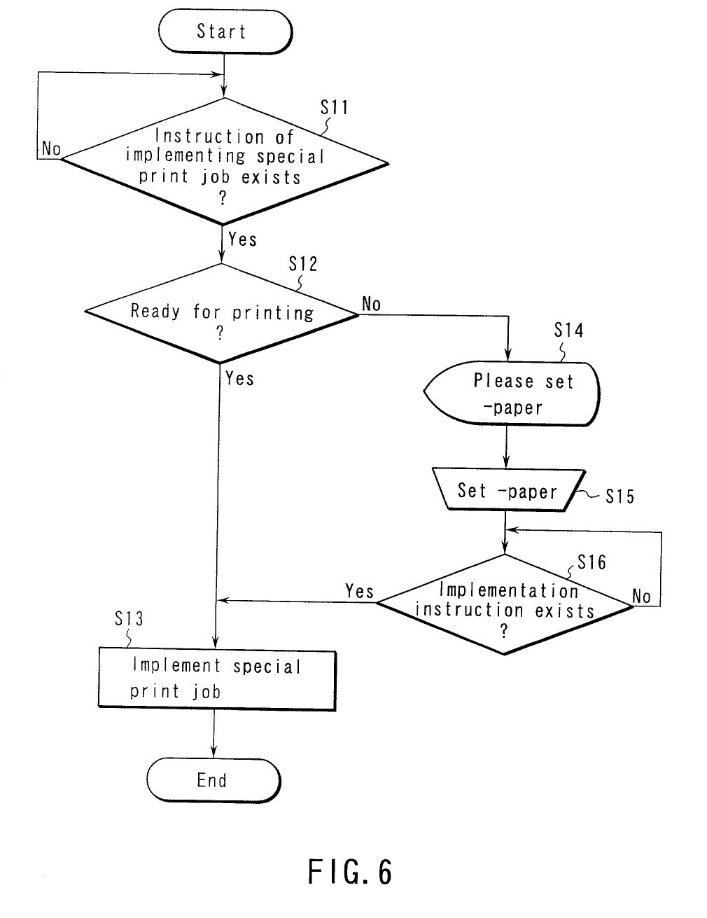

Moreover, FIG. 6 is a flowchart for explaining the procedure of the sub-routine of the process of implementing the special print jobs at step S38 in FIG. 5.

First of all, as shown in FIG. 3, when the print jobs are transmitted from the respective PC terminals 10 via the network (step S1; YES), the print jobs are received via the receiving module 5 of the image processing device 1 (step S2) so that the sub-routine of the receiving process shown in FIG. 4 is implemented.

Besides, the received print jobs are stored to the storing module 6.

As shown in FIG. 4, in the sub-routine of the receiving process, the image processing device 1, at first, receives a notice of starting the transmission of the print job that is sent from the PC terminal 10 being the transmitter (step S21).

Then, the image processing device 1 receives index data (it will be described as job index below) indicating contents of the print job that is sent from the PC terminal 10 being the transmitter (step S22).

Then, the image processing device 1 receives the notice of starting the transmission of page data of the first page included in the print job that is sent from the PC terminal 10 being the transmitter (step S23).

Then, the image processing device 1 receives the index data (it will be described as page index below) indicating the contents of the page data that is sent from the PC terminal 10 being the transmitter (step S24).

Then, the image processing device 1 receives the page data sent from the PC terminal 10 being the transmitter (step S25).

Then, the image processing device 1 receives the notice of ending the transmission of the page data that is sent from the PC terminal 10 being the transmitter (step S26).

Then, the image processing device 1 receives, in the case where the page data of the pages from the second page exists (step S27; YES), the page data of the pages from the second page sent from the PC terminal 10 being the transmitter by repeating the process from step S23 to step S26 by the number of the pages.

Moreover, the image processing device 1 receives, when it is determined that the next page data does not exist at step S27 (step S27; NO), the notice of ending the transmission of the print job that is sent from the PC terminal 10 being the transmitter and ends the action of the receiving process (step S28).

Then, returning to FIG. 3, the image processing device 1, after implementing the sub-routine of the receiving process at step 2 (that is, the process from step S21 to step 28), discriminates whether or not the received print jobs include the special print jobs as described above by using the controlling module 2 (step 3).

When it is discriminated that the received print jobs do not include the special print jobs by the controlling module 2 at step S3 (step S3; NO), the image processing device 1 reads out the print jobs from the storing module 6 and causes the printing module 8 to implement a regular printing process immediately (step S4).

On the other hand, when it is discriminated that the received print jobs include the special print jobs by the controlling module 2 at step S3 (step S3; YES), the image processing device 1 causes the storing module 6 to keep the print jobs including the special print jobs without implementing them (step S5).

That is, the print jobs including the special print jobs are accumulated to the storing module 6 without being implemented.

Then, the image processing device 1 causes the displaying module 3 to display the list of the print jobs including the special print jobs stored to the storing module 6 (step S6).

Under the state where the print jobs including the special print jobs are displayed in a table by the displaying module 3 in this manner, the image processing device 1 transits to step S31 and step S32 of the main process shown in FIG. 5 and waits for the operation by the user for selecting the print job including the special print job.

In this case, it is also considered that the user is not attending near the image processing device 1 so that there may be taken a design in which the image processing device 1 transmits a message “PLEASE IMPLEMENT AN OPERATION FOR SELECTING THE PRINT JOB INCLUDING THE SPECIAL PRINT JOB” to the PC terminal 10 being the transmitter that transmitted the print job including the special print job.

Then, at step S32, as the operation for selecting the print job including the special print job via the inputting module 4 by the user, selection of, for example, the print job including the tabbed paper is implemented.

Here, concerning the selected print job including the special print job, its printing process is not implemented immediately, and it is kept in the storing module 6 in the image processing device 1.

Next, concerning the print job including the special print job that was kept at step S32, the image processing device 1 enables the user to implement the selecting operation by displaying the job list by using the displaying module 3 on the controlling panel 11 in order to make the user select a mode in which the user desires the printing process to be implemented from the above-described modes (step S33).

That is, at step S33 the user selects any one of a mode for implementing the printing after extracting the displayed special print jobs only for the tabbed paper, a mode for implementing the printing after extracting the regular print jobs only for the paper besides the tabbed paper, or a mode for implementing the printing after extracting all of the print jobs including the regular print jobs for the regular paper and the special print jobs for the special paper including the tabbed paper, on the basis of the job list displayed by the displaying module 3 via the inputting module 4 (that is, the user touches the selected item).

Next, at step S34, the image processing device 1 enables the user to implement a designation operation via the inputting module 4 by causing the displaying module 3 to show the user the display for designating whether or not deletion of the printing data after the printing is allowed.

Next, at step S35, the user implements the operation for instructing the start of the printing via the inputting module 4.

Next, the image processing device 1 discriminates the operation for selecting a printing process mode by the user at step S33 and outputs the command for causing the printing module 8 to implement the printing in the printing process mode (step S36).

Next, the image processing device 1, in accordance with the operation for selecting the printing process mode by the user, causes the printing module 8 to implement any one of the first printing mode for extracting the regular print jobs only for the regular paper besides the tabbed paper and for implementing them (step S37), the second printing mode for extracting the special print jobs only for the tabbed paper and for implementing them (step S38), and the third printing mode for extracting all the print jobs including the regular print jobs for the regular paper and the special print jobs for the special paper including the tabbed paper (step S39).

Next, the image processing device 1 discriminates the operation for designating whether or not the deletion of the printing data after the printing is allowed by the user at step S34 (step S40), and in the case where the deletion of the printing data is allowed, deletes the data of the printed job (step S41).

Moreover, in the case where the deletion of the printing data is not allowed, it returns to the process after step S31 while keeping the data of the printed job.

Here, there may be taken a design in which the operation for designating whether or not the deletion of the printing data after the printing is allowed by the user at step S34 above is implemented after implementing the respective printing at step S37, step S38, and step S39.

Besides, in this case, after the printing, it prompts the user to designate whether or not the printing data is deleted.

Accordingly, there may be taken a design in which a predetermined time-out process is implemented since it is possible that the user leaves without implementing any operation in this case.

Moreover, there may be taken a design in which the operation for designating whether or not the deletion of the printing data after the printing is allowed by the user at step S34 above is implemented before the operation for selecting the printing process mode by the user at step S33.

In this case, it also becomes possible to immediately delete the job selected by the user without printing it.

Next, an explanation will be given of the sub-routine for implementing the print jobs including the special print jobs for the paper including the tabbed paper at step S38 above by using the flowchart shown in FIG. 6.

As shown in FIG. 6, when the command for instructing the implementation of the print jobs including the special print jobs at step S36 above is output (step S11; YES), on the condition that the image processing device 1 is ready for the print jobs (step S12; YES), the print jobs including the special print jobs are implemented by the printing module 8 (step S13).

Meaning of being ready for the printing here is that, for example, the tabbed paper used for the special print jobs is set in the predetermined feeding cassettes 9a and 9b or the manually-feeding tray.

On the other hand, when it is determined via the sensor 90 that, for example, the tabbed paper is not set and that preparation for the printing has not been done at step S12, an operation guidance “PLEASE SET TABBED PAPER” is displayed via the displaying module 3 (step S14).

The user confirms the operation guidance and sets the tabbed paper in the predetermined feeding cassettes 9a and 9b or the manual-feeding tray (step 15).

Then, on the condition that the instruction for implementing the print jobs including the special print jobs is done again by the user (step S16; YES), the print jobs including the special print jobs is implemented at step S13.

Here, an explanation will be given of a technique of the discriminating process by the controlling module 2 at step S3 by giving several examples.

In the first example, the controlling module 2 discriminates whether or not the page index of each page received at step S24 includes information relating to the special print job during the process of receiving the print jobs at step S2.

In this case, as the information relating to the special print job, there are a tabbed paper flag for indicating the printing on the tabbed paper, the information relating to the feeder, size information, and the like.

Now, two types of image processing devices to which such a first example is applied are roughly possible.

The image processing device of the first type implements the print jobs after completing the process of receiving the print jobs.

The image processing device of the second type prints each page during the process of receiving the print jobs by sending each page data received at step S25 to the printing module 8 every time it is received.

In the image processing device of the first type, the controlling module 2 determines whether or not the page index including the special printing is received when the reception of the print jobs are completed.

Then, when there is no page index including the special print job in the received print jobs, the image processing device of this type stores the print job to the storing module 6 while immediately implementing it by the printing module 8.

On the other hand, when there is the page index including the special print job in the received print jobs, the image processing device of this type stores the print job including the special print job to the storing module 6 while displaying it via the displaying module 3.

In the image processing device of the second type, at the moment of determining that the page index includes the information relating to the special print job during the reception process, the controlling module 2 suspends the print job when the print job has already been implemented, and transits to the process at step S5 in FIG. 3.

Moreover, at the moment of determining that the page index including the special print job is received, the image processing device of this type immediately transits to the process at step S5 when the print job has not been implemented yet.

In the second example, the controlling module 2 discriminates whether or not the job index of the print job received at step S22 includes the information relating to the special print job during the process of receiving the print job at step S2.

In this case, at the moment of determining that the job index including the special print job is received, the image processing device transits to the process at step 5.

Besides, it is sufficient to implement the mode for extracting the regular print jobs only for the paper besides the tabbed paper and for implementing the printing (step S38) in FIG. 5 in a similar manner to the implementation of the regular print jobs.

Moreover, it is sufficient to implement the mode for extracting all the print jobs including the regular print jobs for the regular paper and the special print jobs for the special paper including the tabbed paper and for implementing the printing (step S39) in a similar manner to the implementation of the regular print jobs in addition to the sub-routine for implementing the mode for extracting the special print jobs only for the tabbed paper and for implementing the printing (step S38) shown in FIG. 5.

As above, according to the above-described embodiment, the image processing device 1 is designed so as to, when the print jobs including the special print jobs for the special paper such as the tabbed paper are received by the receiving module 5, discriminate whether or not the print job received by the receiving module 5 includes the special print job by using the controlling module 2, and control the implementation of the printing by using the printing module 8.

Moreover, it is designed so that, in the case where the print jobs include the special print jobs, the controlling module 2 can extract the special print jobs from the storing module 6 and control the printing module to implement the special print jobs.

Moreover, it is designed so that, in the case where it is discriminated that the print jobs include the special print jobs, the controlling module 2 can extract the print jobs besides the special print jobs from the storing module and control the printing module to implement the print jobs besides the special print jobs.

Besides, the controlling module 2 includes a first discriminating module 2 for discriminating whether or not the print jobs include the special print jobs, and a second discriminating module 2 for, in the case where the first discriminating module 2 discriminates that the print jobs include the special print jobs, extracting at least a part of the special print jobs from the storing module 6 and for discriminating whether or not the printing module 8 should be controlled to implement at least a part of the special print jobs.

Moreover, the controlling module 2 further includes a third discriminating module 2 for, in the case where the second discriminating module 2 discriminates that the printing module should be controlled to implement at least a part of the special print jobs, discriminating whether or not at least a part of the special print jobs should be deleted from the storing module 6 after the printing module 8 implements at least a part of the special print jobs.

At this time, the image processing device 1 is designed so as to store the print jobs including the special print jobs to the storing module 6 without immediately implementing them while displaying them via the controlling module and displaying module 3.

Then, the image processing device 1 is designed so as to read out the print jobs including the special print jobs from the storing module 6 and to implement them at the printing module 8 on the condition that the implementation of the print jobs including the special print jobs is instructed by the user via the inputting module 4.

Owing to this, when, for example, the special paper such as the tabbed paper used for the special print jobs is not prepared or a jam occurs during printing on the special paper, the user is attending near the image processing device 1 so that the user can deal with the trouble immediately.

Accordingly, it is efficient since a time during which the following print jobs are made to wait because lack of the paper or the jam is left unnoticed can be reduced to an extremely short time so that an operating ratio of the image processing device will be raised.

Moreover, the image processing device 1 is designed so that the print jobs including the special print jobs will be kept in its storing module 6 and the list thereof will be displayed. Therefore, the convenience can be improved since the user can implement the print jobs by going to the image processing device 1 at a proper timing.

Moreover, it is also possible for the user to, when the print jobs including the special print jobs are implemented, implement the special print jobs tentatively or adjust a printing position for a tab by actually looking at the tabbed paper that is printed and output.

(Second Embodiment)

Hereinafter, an explanation will be given of a second embodiment of the present invention.

The second embodiment is applied to the cases where a user can previously select any of a first printing mode for extracting regular print jobs only for regular paper besides tabbed paper and for implementing them, a second printing mode for extracting special print jobs only for the tabbed paper and for implementing them, and moreover, a third printing mode for extracting all the print jobs including the regular print jobs for the regular paper and the special print jobs for the special paper including the tabbed paper, on a printer driver 12 shown in FIG. 1.

Here, it is assumed that the printer driver 12 comprises a controlling module 2 having similar functions to at least those of the image processing device 1, an operation panel 11 with a touch-panel style that has functions as a displaying module 3 and as an inputting module 4, and a storing module 6 for storing the print jobs and the like, in order to make it possible to externally drive the image processing device 1 shown in FIG. 2.

That is, the second embodiment is applied to the case where the user implements display of a list of the print jobs including the special print jobs in a main process shown in FIG. 5 (step S31), an operation for selecting the print job including the special print job by the user (step S32), an operation of selecting any one of the printing only on the paper besides the tabbed paper, the printing only on the tabbed paper, or the printing on the paper besides the tabbed paper and the tabbed paper by the user (step S33), an operation for designating whether or not deletion of printing data after the printing is allowed (step S34), and an operation for instructing start of the printing (step S35) by using the printer driver 12 shown in FIG. 1.

Then, concerning discriminant of the operation for selecting a printing process mode (step S36), implementation of any one of, in accordance with the operation for selecting the printing process mode by the user, a first printing mode for extracting the regular print jobs only for the regular paper besides the tabbed paper and for implementing them (step S37), a second printing mode for extracting the special print jobs only for the tabbed paper and for implementing them (step S38), and a third printing mode for extracting all the print jobs including the regular print jobs for the regular paper and the special print jobs for the special paper including the tabbed paper (step S39), discriminant of the operation for designating whether or not the deletion of the printing data after the printing is allowed (step S40), and deletion of the data of the printed job in the case where the deletion of the printing data is allowed (step S41) in FIG. 5, they are similar to the case of the above-described first embodiment.

In such a second embodiment, convenience can further be improved since the user can previously select on the printer driver 12 any one of the first printing mode for extracting the regular print jobs only for the regular paper besides the tabbed paper and for implementing them, the second printing mode for extracting the special print jobs only for the tabbed paper and for implementing them, and moreover, the third printing mode for extracting all the print jobs including the regular print jobs for the regular paper and the special print jobs for the special paper including the tabbed paper.

(Third Embodiment)

Hereinafter, an explanation will be given of a third embodiment of the present invention.

The third embodiment is applied to the case where designation of printing and deletion can be implemented after jam or suspension occurs.

A basic structure of the third embodiment is similar to that of the printing system 100 shown in FIG. 1 and the image processing device 1 shown in FIG. 2.

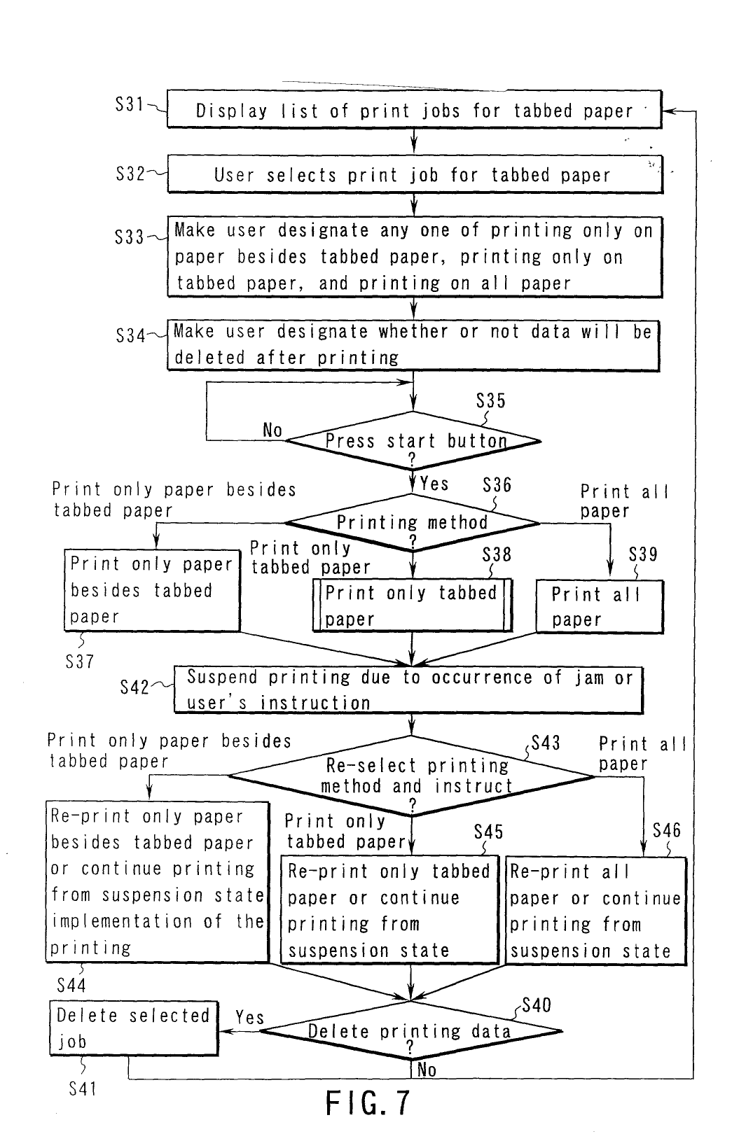

An explanation will be given of processing procedures of main portions of the action of the third embodiment below with reference to the flowchart shown in FIG. 7.

That is, in FIG. 7, the processing procedures from step S31 to step S39 are similar to those in the flowchart of the first embodiment shown in FIG. 5.

In FIG. 7, it is assumed that the printing is suspended (step S42) due to occurrence of a jam or instruction by the user while a printing module 8 is caused to implement any one of a first printing mode for extracting the regular print jobs only for the regular paper besides the tabbed paper and for implementing them (step S37), a second printing mode for extracting the special print jobs only for the tabbed paper and for implementing them (step S38), and a third printing mode for extracting all the print jobs including the regular print jobs for the regular paper and the special print jobs for the special paper including the tabbed paper (step S39).

Next, the image processing device 1 prompts the user to re-select any one of reprinting of only the paper besides the tabbed paper, the reprinting of only the tabbed paper, the reprinting of all the paper including the paper besides the tabbed paper and the tabbed paper, and continuous printing from the respective printing suspension states, and to implement the operation for instructing implementation of this printing (step S43).

Next, the image processing device 1 implements any one of the reprinting of only the paper besides the tabbed paper or the continuous printing from the state of suspension of the printing of only the paper besides the tabbed paper (step S44), the reprinting of only the tabbed paper or the continuous printing from the state of suspension of the printing of only the tabbed paper (step S45), and the reprinting of all the paper including the paper besides the tabbed paper and the tabbed paper or the continuous printing from the state of suspension of the printing of all the paper including the paper besides the tabbed paper and the tabbed paper (step S46) in accordance with the re-selection and the operation for instructing the implementation of the printing by the user at step S43.

Then, concerning the discriminant of the operation for designating whether or not the deletion of the printing data after the printing is allowed (step S40), and the deletion of the data of the printed job in the case where the deletion of the printing data is allowed (step S41) in FIG. 7, they are similar to the case of the above-described first embodiment.

Besides, there may be omitted the procedure of the operation for instructing the implementation of the printing after the user is prompted to select any one of them at step S43.

In such a third embodiment, the designations for the printing and the deletion after occurrence of the jam or suspension are possible so that convenience can further be improved.

(Altered Example)

Besides, as an altered example, it is also possible to combine the above-mentioned first, second, and third embodiments and implement them.

By doing that, it becomes possible to re-implement printing including tabbed paper after printing only the tabbed paper tentatively, or to re-implement the printing only on the tabbed paper, only on the paper besides the tabbed paper, or on all the paper including the tabbed paper even when jam occurs during the printing of the paper including the tabbed paper.

Accordingly, as described above in detail, according to the present invention, there can be provided the image forming device and the method of controlling the same that is designed so as to be able to effectively deal with the special print jobs using the tabbed paper and the like, by making it possible to implement, concerning, for example, the printing on the tabbed paper, which can be failed more easily comparing with the printing on the regular paper due to the factors such as a jam or printing position adjustment, the trial printing only on the tabbed paper since damage of failure of the printing can be mitigated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming device comprising:
a receiving module which receives print jobs from outside;
a storing module which stores the print jobs received by the receiving module;
a printing module which implements the print jobs stored by the storing module; and
a controlling module which discriminates whether or not the print jobs received by the receiving module include special print jobs, and controls implementation of printing done by the printing module.

2. An image forming device according to claim 1,
wherein the special print jobs are print jobs for printing paper including at least one of thick paper, thin paper, colored paper, and tabbed paper which are different from regular paper.

3. An image forming device according to claim 1,
wherein the controlling module, in the case where the print jobs include the special print jobs, extracts the special print jobs from the storing module and controls the printing module to implement the special print jobs.

4. An image forming device according to claim 1,
wherein the controlling module, in the case where it is discriminated that the print jobs include the special print jobs, extracts the print jobs besides the special print jobs from the storing module and controls the printing module to implement the print jobs besides the special print jobs.

5. An image forming device according to claim 1,
wherein the controlling module includes a first discriminating module which discriminates whether or not the print jobs include the special print jobs, and a second discriminating module which, in the case where the first discriminating module discriminates that the print jobs include the special print jobs, extracts at least a part of the special print jobs from the storing module and, discriminates whether or not the printing module should be controlled to implement at least a part of the special print jobs.

6. An image forming device according to claim 5,
wherein the controlling module further includes a third discriminating module which, in the case where the second discriminating module discriminates that the printing module should be controlled to implement at least a part of the special print jobs, discriminates whether or not at least a part of the special print jobs should be deleted from the storing module after the printing module implements at least a part of the special print jobs.

7. An image forming device comprising:
receiving means for receiving print jobs from outside;
storing means for storing the print jobs received by the receiving means;
printing means for implementing the print jobs stored by the storing means; and
controlling means for discriminating whether or not the print jobs received by the receiving means include special print jobs, and controlling implementation of printing done by the printing means.

8. An image forming device according to claim 7,
wherein the special print jobs are print jobs for printing paper including at least one of thick paper, thin paper, colored paper, and tabbed paper which are different from regular paper.

9. An image forming device according to claim 7,
wherein the controlling means, in the case where the print jobs include the special print jobs, extracts the special print jobs from the storing means and controls the printing means to implement the special print jobs.

10. An image forming device according to claim 7,
wherein the controlling means, in the case where it is discriminated that the print jobs include the special print jobs, extracts the print jobs besides the special print jobs from the storing means and controls the printing means to implement the print jobs besides the special print jobs.

11. An image forming device according to claim 7,
wherein the controlling means includes a first discriminating means for discriminating whether or not the print jobs include the special print jobs, and a second discriminating means for, in the case where the first discriminating means discriminates that the print jobs include the special print jobs, extracting at least a part of the special print jobs from the storing means and, discriminating whether or not the printing means should be controlled to implement at least a part of the special print jobs.

12. An image forming device according to claim 11,
wherein the controlling means further includes a third discriminating means for, in the case where the second discriminating means discriminates that the printing means should be controlled to implement at least a part of the special print jobs, discriminating whether or not at least a part of the special print jobs should be deleted from the storing means after the printing means implements at least a part of the special print jobs.

13. A method of controlling an image forming device for implementing print jobs from outside comprising:
receiving print jobs from outside;
storing of the print jobs to a storing portion;
implementing the print jobs stored to the storing portion; and
discriminating whether or not the print jobs include special print jobs and controlling implementation of the print jobs.

14. A method of controlling the image forming device according to claim 13,
wherein the special print jobs are print jobs for printing paper including at least one of thick paper, thin paper, colored paper, and tabbed paper which are different from regular paper.

15. A method of controlling the image forming device according to claim 13,
wherein the controlling, in the case where the print jobs include the special print jobs, extracts the special print jobs from the storing portion and causes the print jobs to be implemented.

16. A method of controlling the image forming device according to claim 13,
wherein the controlling, in the case where it is discriminated that the print jobs include the special print jobs, extracts the print jobs besides the special print jobs from the storing portion and causes the print jobs besides the special print jobs to be implemented.

17. A method of controlling the image forming device according to claim 13,
wherein the controlling includes first discriminating which discriminates whether or not the print jobs include the special print jobs, and second discriminating which, in the case where the first discriminating discriminates that the print jobs include the special print jobs, extracts at least a part of the special print jobs from the storing portion and, discriminates whether or not at least a part of the special print jobs should be implemented.

18. A method of controlling the image forming device according to claim 17,
wherein the controlling further includes third discriminating which, in the case where the second discriminant discriminates that at least a part of the special print jobs should be implemented, discriminates whether or not at least a part of the special print jobs should be deleted from the storing portion after at least a part of the special print jobs is implemented.
